(19) United States
(12) Patent Application Publication
(10) Pub. No.: US 2003/0081794 A1
(43) Pub. Date: May 1, 2003

(54) Insert earphone

(75) Inventors: Isao Fushimi, Shizuoka (JP); Seiichi Tanaka, Shizuoka (JP)

Correspondence Address: SUGHRUE MION, PLLC, 2100 PENNSYLVANIA AVENUE, N.W., WASHINGTON, DC, 20037, US

(73) Assignee: STAR MICRONICS CO., LTD.

(21) Appl. No.: 10/281,246

(22) Filed: Oct. 28, 2002

(30) Foreign Application Priority Data
Oct. 31, 2001 (JP) P2001-335895

(51) Int. Cl. H04R 1/10

(52) U.S. Cl. 381/74

(57) ABSTRACT

An insert earphone which attains desired acoustic characteristics. A receiver unit having a sound passage tube comprises a receiver main body and a housing accommodating the receiver main body. The sound passage tube includes an outer tube portion integrally formed with a frame of the housing and an inner tube member inserted into an inner space of the outer tube portion. The inner tube member is provided separately from the frame. A sound passage can be easily defined in any shape to obtain a desired acoustic characteristics. Plural kinds of insert earphones having different acoustic characteristics are manufactured by preparing plural kinds of inner tube members. This contributes to reduction in cost compared with a case of manufacturing plural kinds of frames.

### BACKGROUND OF THE INVENTION

1. Field of the Invention

The present invention relates to an insert earphone, particularly to a structure of a sound passage tube thereof.

2. Description of the Related Art

An insert earphone conventionally comprises a receiver unit having a sound passage tube, and an ear chip attached to the receiver unit. The insert earphone is used in state where the ear chip is inserted into an external auditory meatus.

The insert earphone has different acoustic characteristics depending on the length or sectional area of the sound passage tube, that is, depending on the shape of a sound passage. Also, the acoustic characteristics are different depending on the kind of an acoustic filter attached to the sound passage tube.

Since the receiver unit in the conventional insert earphone has the sound passage tube formed integrally with a housing which accommodates a receiver main body, it has a disadvantage in that the sound passage is defined only in a simple shape and a desired acoustic characteristics can not be easily obtained.

In case the insert earphones adapted to each purpose such as entertainment, music or speech communication are manufactured so as to obtain the best acoustic characteristics for each purpose, plural kinds of housings need to be manufactured. Thus, plural kinds of molds for the housings are necessary, causing an increase of the manufacturing cost of the insert earphones.

### SUMMARY OF THE INVENTION

An object of the present invention is to provide an insert earphone which attains the desired acoustic characteristics.

Another object of the present invention is to manufacture plural kinds of insert earphones having different acoustic characteristics at low cost.

The insert earphone of the present invention achieves the objects by providing a sound passage tube of an improved structure.

According to an aspect of the present invention, there is provided an insert earphone adapted to be inserted into an external auditory meatus, comprising:

a receiver unit having a sound passage tube, the receiver unit comprising a receiver main body and a housing which accommodates the receiver main body; and

an ear chip attached to the receiver unit;

wherein the sound passage tube comprises an outer tube portion integrally formed with the housing and an insertion member inserted into an inner space of the outer tube portion.

The housing is not limited to the one as herein described. As far as the receiver main body is accommodated and the outer tube portion is integrally formed, any type of the housing is applicable to the present invention regardless of the material and the shape.

The insertion member is not limited to the one as herein described. As far as it is formed to be inserted into the inner space of the outer tube portion and is formed with a through hole or a groove extending in an axial direction of the outer tube portion, any type of the insertion member is applicable to the present invention regardless of the material, the length and the shape. Any type of the through hole or the groove is applicable to the present invention regardless of the shape, the number and the arrangement.

According to the insert earphone of the present invention, the sound passage tube comprises the outer tube portion integrally formed with the housing which accommodates the receiver main body and the insertion member inserted into the inner space of the outer tube portion. This structure has the following advantages.

The insert earphone has a sound passage which is partly or entirely defined by the through hole or the groove formed in the insertion member. Since the insertion member is made separately from the housing, a through hole or groove of a desired shape can be easily formed. Therefore, the sound passage of a relatively complex shape can be defined and thereby a desired acoustic characteristics can be easily obtained.

Plural kinds of insert earphones having different acoustic characteristics are manufactured by producing plural kinds of insertion members. This contributes to reduction in cost compared with the conventional case of manufacturing plural kinds of housings requiring molds for every housing. Thus, cost for manufacturing plural kinds of insert earphones is reduced.

As described above, according to the insert earphone of the present invention, a desired acoustic characteristics can be easily attained. Plural kinds of insert earphones having different acoustic characteristics can be manufactured at low cost.

The insertion member may have a flange on a top end portion thereof, which comes into contact with a top end face of the outer tube portion to axially position the insertion member, and thereby a desired acoustic characteristics can be surely obtained.

The flange may be formed with a notch, and a projection engaging with the notch may be formed on the top end face of the outer tube portion to circumferentially position the insertion member, and thereby a desired acoustic characteristics can be surely obtained.

The insert earphone may have an acoustic filter attached to the insertion member to surely obtain a desired acoustic characteristics by appropriately selecting the kind of the acoustic filter. The acoustic filter may be attached to the insertion member during the manufacturing process, so that the insertion member with the acoustic filter can be handled as one unit. The insert earphones having different acoustic characteristics can be easily manufactured by preparing plural kinds of insertion member having the different acoustic filter. The acoustic filter may be attached to the top end portion, the base end portion or the middle portion of the insertion member.

The insert earphone may have the through hole or groove formed in the shape of a spiral. This enables the sound passage to be longer than the length of the insertion member, and thereby the acoustic characteristics having a sound pressure peak in lower sound range can be obtained.

The insertion member may be detachably attached to the outer tube portion. This enables the insertion member to be replaced to the other one having different acoustic characteristics, and thereby the insert earphones having different acoustic characteristics can be easily obtained.

### BRIEF DESCRIPTION OF THE DRAWINGS

FIG. 1 is a partially sectional side view of an insert earphone of the present invention.

FIG. 2 is a partial side sectional view of the insert earphone.

FIG. 3 is a partial exploded perspective view of the insert earphone.

FIG. 4 is a partial sectional side view showing a second embodiment of the present invention.

FIG. 5(a) is a partial sectional side view showing a third embodiment of the present invention.

FIG. 5(b) is a partial sectional side view showing a fourth embodiment of the present invention.

### DETAILED DESCRIPTION OF THE PREFFERED EMBODIMENTS

The present invention will be described below with reference to the accompanying drawings.

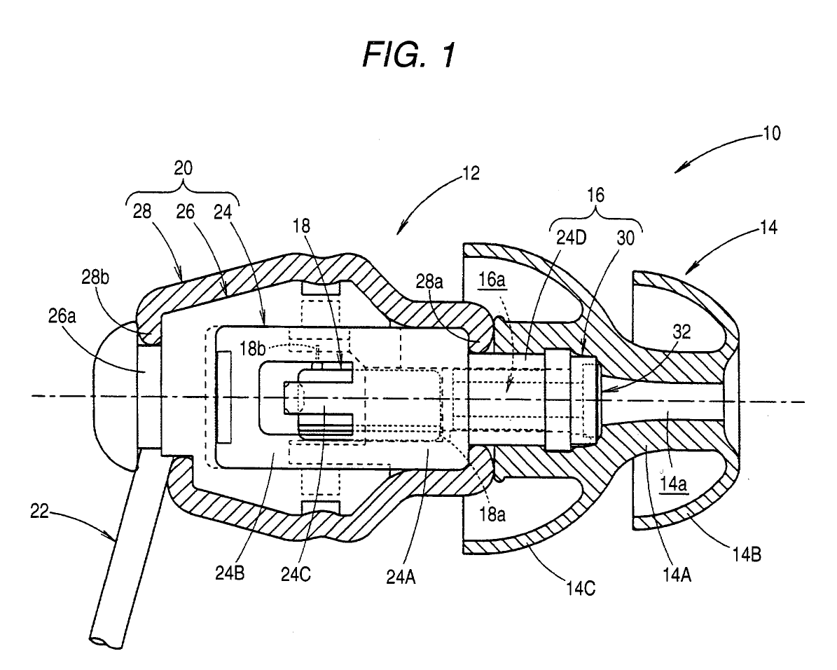

FIG. 1 is a partially sectional side view of an insert earphone 10 of the present invention.

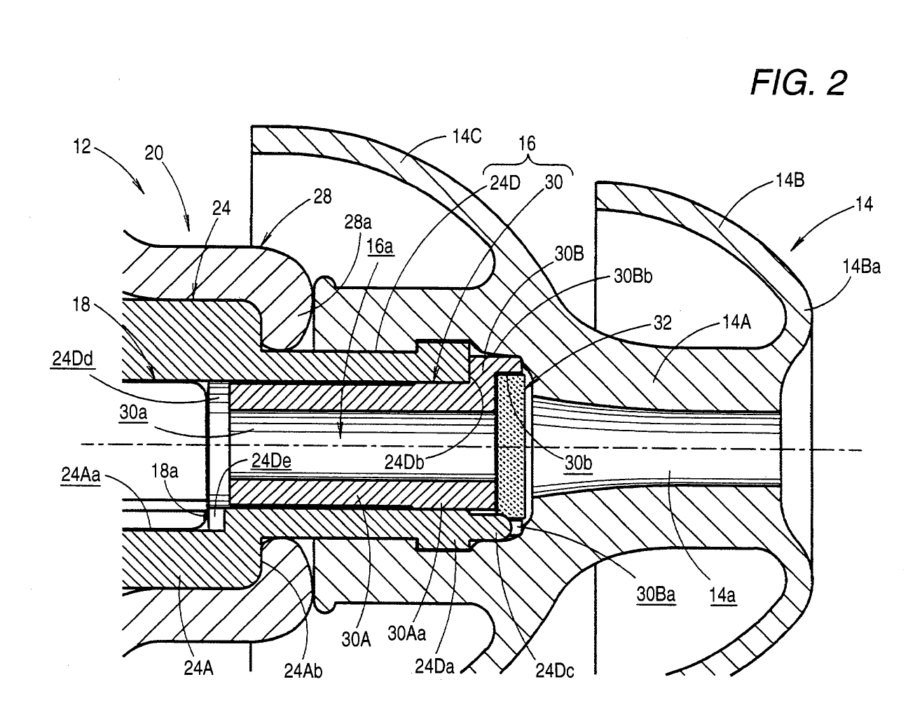

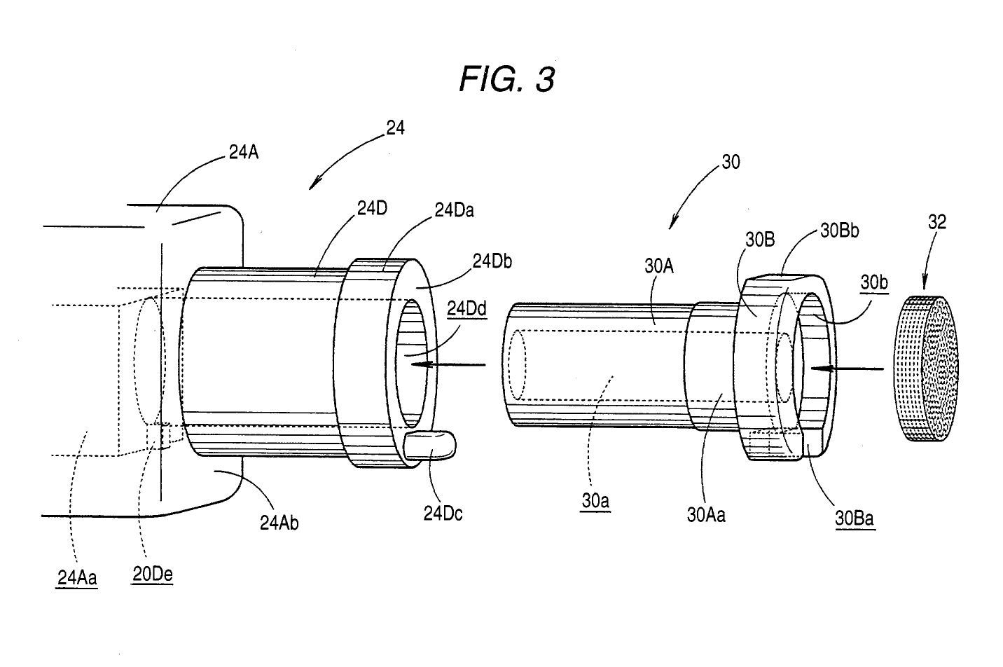

FIGS. 2 and 3 are a partial side sectional view and a partial exploded perspective view respectively showing the insert earphone 10.

As shown in these drawings, the insert earphone 10 comprises a receiver unit 12 and an ear chip 14. The receiver unit 12 has a sound passage tube 16 on a front end portion thereof (right end portion in FIG. 1). The ear chip 14 is fitted to the sound passage tube 16. The insert earphone 10 is used in state where the ear chip 14 is inserted into an external auditory meatus.

The receiver unit 12 comprises a receiver main body 18, a housing 20 accommodating the receiver main body 18, and a cord 22 connected to the receiver main body 18.

The receiver main body 18 comprises an electromagnetic receiver of a balance armature type which has substantially a rectangular parallelepiped outer shape. The receiver main body 18 has a sound release hole 18a formed at a lower part of the front end face thereof and a terminal 18b disposed on an upper face in the vicinity of a rear end thereof. The receiver main body 18 radiates a sound wave through the sound release hole 18a in accordance with a signal current transmitted from the terminal 18b via the cord 22.

The housing 20 comprises a frame 24 for containing the receiver main body 18, a cord fixing block 26 securely fitted to the frame 24 from the rear side while an end of the cord 22 connected thereto, and an outer covering member 28 for covering the frame 24 and the cord fixing block 26.

The frame 24 is made of synthetic resin such as polycarbonate resin by injection molding. The frame 24 comprises a receiver main body inserting portion 24A having an insertion space 24Aa into which the front portion of the receiver main body 18 is inserted from the rear side, and a block fitting portion 24B extending rearward from the receiver main body inserting portion 24A to be fitted with the cord fixing block 26. The frame 24 further comprises a pair of elastic engaging pieces 24C, formed by cutting part of left and right sides of the block fitting portion 24B, for elastically engaging with the rear end portion of the receiver main body 18 at the left and right sides. The frame 24 further comprises an outer tube portion 24D extending forward from a front end face 24Ab of the receiver main body inserting portion 24A.

The cord fixing block 26 is made of synthetic resin such as ABS resin by injection molding, and formed in the shape of a letter “U” in a side view so as to correspond to the shape of the block fitting portion 24B of the frame 24. An annular groove 26a is formed near the rear end of the cord fixing block 26. The cord 22 is inserted into the cord fixing block 26 through an insertion bore (not shown) formed at a lower part of the annular groove 26a, and an end of the cord 22 is connected to the terminal 18b of the receiver main body 18 via a substrate (not shown). A knot is made near the end of the cord 22 connected to the terminal 18b so that the knot hits the cord fixing block 26 when the cord 22 is pulled from outside, preventing a displacement of the cord 22.

The outer covering member 28 is made of soft material such as silicone rubber and is elastically deformed to some extent in state where it covers the frame 24 and the cord fixing block 26. The outer covering member 28 is cylindrical in shape before assembly, and annular flange portions 28a, 28b are formed at both axial ends thereof. The outer covering member 28 is fitted from the rear side over the frame 24 and the cord fixing block 26 by spreading out the annular flange portion 28a. In a fitted state, the annular flange portion 28a engages with a front end face 24Ab of the receiver main body inserting portion 24A of the frame 24, and the annular flange portion 28b engages with the annular groove 26a of the cord fixing block 26. The annular flange portion 28b is partly displaced forward so as to detour the cord 22 at the lower part of the annular groove 26a.

The outer tube portion 24D of the frame 24 has an annular flange portion 24Da projecting toward the outer circumference at a front end portion thereof, and a projection 24Dc projecting forward at a lower part of a front end face 24Db of the annular flange portion 24Da. An inner space 24Dd of the outer tube portion 24D communicates to the insertion space 24Aa of the receiver main body inserting portion 24A. A notch 24De is formed on a lower face at the rear end portion of the inner space 24Dd. This notch 24De prevents the sound release hole 18a from being clogged in state where the receiver main body 18 is inserted into the receiver main body inserting portion 24A. Communication with the inner space 24Dd and a through hole 30a (described below) is thereby available. An inner tube member 30 is detachably inserted from the front side into the inner space 24Dd of the outer tube portion 24D. The outer tube portion 24D and the inner tube member 30 constinute the sound passage tube 16.

The inner tube member 30 is made of synthetic resin such as ABS resin by injection molding. The inner tube member 30 comprises a cylindrical portion 30A and a flange portion 30B formed on a front end portion of the cylindrical portion 30A to project toward the outer circumference. A through hole 30a formed in the center of the inner tube member 30 has a filter receiving portion 30b of large diameter at a front end thereof. The outer diameter of the cylindrical portion 30A at the region near the front end 30Aa is set to be substantially same as the inner diameter of the outer tube portion 24D. The outer diameter of the cylindrical portion 30A at the region which extends rearward from the region 30Aa, is set to be slightly smaller than the inner diameter of the outer tube portion 24D. The flange portion 30B has a notch 30Ba at its lower end and a chamfer 30Bb horizontally chamfered at its upper end.

The flange portion 30B comes into contact with the front end face 24Db of the outer tube portion 24D to axially position the inner tube member 30 when the inner tube member 30 is inserted into the outer tube portion 24D. The notch 30Ba engages with the projection 24Dc to circumferentially position the inner tube member 30 with respect to the outer tube portion 24D. The inner tube member 30 is slidably engaged with the outer tube portion 24D at the region near the front end 30Aa of the cylindrical portion 30A.

In state where the inner tube member 30 is inserted into the outer tube portion 24D, a sound passage 16a of the sound passage tube 16 is defined. The sound passage 16a is defined by the through hole 30a of the inner tube member 30 and the inner space 24Db of the outer tube portion 24D extending slightly from the rear side of the through hole 30a.

In the filter receiving portion 30b of the inner tube member 30, a disc-shaped acoustic filter 32 made of nonwoven fabric is bonded by an adhesive or a double-faced tape.

The ear chip 14 is made of soft material such as silicone rubber. The ear chip 14 comprises a barrel portion 14A, and first and second annular flange portions 14B and 14C.

The barrel portion 14A defines a sound passage 14a communicating to the sound passage 16a when connected to the sound passage tube 16 of the receiver unit 12. The first annular flange portion 14B is the shape of a parabola spreading from the top end of the barrel portion 14A toward the middle thereof. The second annular flange portion 14C is the shape of a parabola spreading from the middle of the barrel portion 14A toward the base end thereof.

The first annular flange portion 14B has almost even thickness from its inner circumference to the outer circumference. The second annular flange portion 14C has greater thickness at the inner circumference, and has almost even thickness in the other regions of the entire periphery. The outer diameter of the first annular flange portion 14B is smaller than that of the second annular flange portion 14C. The first annular flange portion 14B has an inner circumference neighborhood 14Ba which is substantially formed in a sliced doughnut shape. The shape of a sliced doughnut is formed by rotating the shape of a circular arc at the section taken along a plane containing the central axis Ax of the barrel portion 14a.

As above described, the insert earphone 10 of the present invention comprises the receiver unit 12 having the sound passage tube 16. The sound passage tube 16 is structured by the outer tube portion 24D formed integrally with the frame 24 which is a part of the housing 20 accommodating the receiver main body 18, and the inner tube member 30 inserted into the inner space 24Dd of the outer tube portion 24D. This structure has the following advantages.

The sound passage 16a of the insert earphone 10 is mostly defined by the through hole 30a of the inner tube member 30. Since the inner tube member 30 is provided separately from the frame 24, the through hole 30a can be easily formed in any shape. Therefore, the sound passage can be defined in a relatively complex shape by appropriately designing the inner tube member 30, and thereby a desired acoustic characteristics can be easily obtained

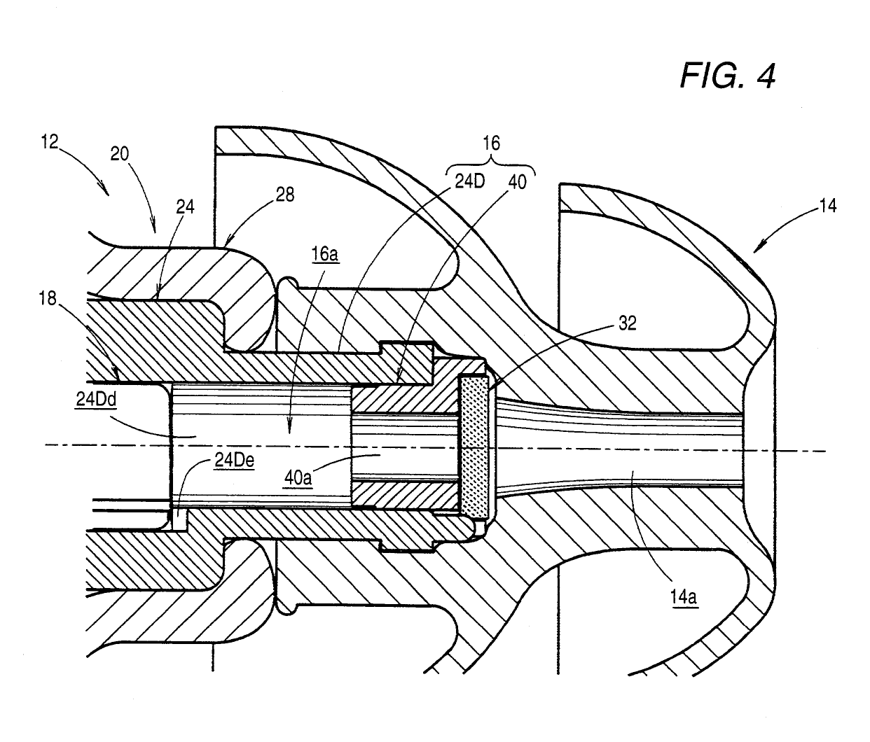

In case where an inner tube member 40 having a shorter length than the inner tube member 30 is applicable as shown in FIG. 4, a different sound passage is defined, in which a through hole 40a is short and the inner space 24Dd of the outer tube portion 24D is long, and the acoustic characteristics suitable for speech communications can be obtained. In case where the inner tube member 30 having a long total length is applicable as shown in FIG. 2, the acoustic characteristics suitable for music appreciation can be obtained.

Further, in case where the acoustic filter is provided on a rear end portion (portion located opposite to the sound release bore 18a) of the inner tube member 30, the peak sound pressure is suppressed and the sound pressure is smoothed over the frequency, and thereby the acoustic characteristics suitable for music appreciation can be obtained.

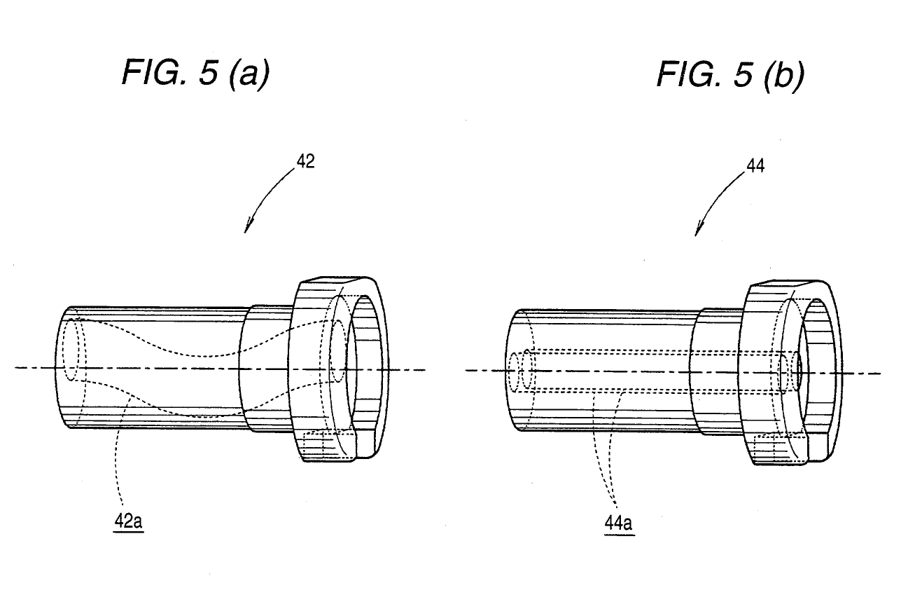

An inner tube member 42 having a through hole 42a formed spirally as shown in FIG. 5(a) may be applicable. Further, an inner tube member 44 having two through holes 44a of small diameter disposed side by side as shown in FIG. 5(b) may be applicable. In case where the inner tube member 42 as shown in FIG. 5(a) is employed, the through hole 42a formed spirally enables the sound passage to be longer than the total length of the inner tube member 42, Thereby the acoustic characteristics having a peak sound pressure in a lower sound range can be obtained. In case where the inner tube member 44 as shown in FIG. 5(b) is employed, a pair of through holes 44a enables the acoustic characteristics to be excellent in reproducing the high sound range.

Further, plural kinds of the insert earphones having different acoustic characteristics are manufactured by producing plural kinds of inner tube members 30. This contributes to reduction in cost compared with a case of manufacturing plural kinds of frames 24 which would require molds for every frame.

According to the insert earphone of the present invention, a desired acoustic characteristics can be easily attained. Plural kinds of insert earphones having different acoustic characteristics can be manufactured at low cost.

In the above described embodiment, the housing 20 of the insert earphone 10 is structured by the frame 24, cord fixing block 26 and the outer covering member 28. In case where a housing consisting of a single member is employed, plural kinds of housings need be prepared to manufacture plural kinds of insert earphones having different acoustic characteristics. The present invention is applied very effectively to such case.

In the above described embodiment, the top end portion of the inner tube member 30 is formed with the flange portion 30B which comes into contact with the front end face 24Db of the outer tube portion 24D, thereby the inner tube member 30 is easily axially positioned with respect to the outer tube portion 24D and the desired acoustic characteristics can be surely obtained.

Further, the flange portion 30B of the inner tube member 30 has the notch 30Ba, and the top end face 24Db of the outer tube portion 24D has the projection 24Dc engaging with the notch 30Ba, thereby the inner tube member 30 is easily circumferentially positioned with respect to the outer tube portion 24D and the desired acoustic characteristics can be surely obtained.

Further, the acoustic filter 32 is provided at the front end portion of the inner tube member 30. Thus, the desired acoustic characteristics can be more easily obtained by appropriately selecting the kind of the acoustic filter 32. Further, since the acoustic filter 32 is fixed beforehand in the inner tube member 30, the inner tube member 30 with the acoustic filter 32 can be handled as one unit. Accordingly, the insert earphones having different acoustic characteristics can be easily manufactured by preparing plural kinds of inner tube members 30 having the different acoustic filter 32. As far as the acoustic filter 32 can pass the sound containing inertance and cause a ventilation resistance, any type of acoustic filter maybe applicable. As a material of the acoustic filter, felt, meshed fabric or the like may be applicable in addition to the nonwoven fabric.

In the above described embodiment, the inner tube member 30 is detachably inserted into the inner space 24Dd of the outer tube portion 24D. Instead of the inner tube member 30, the inner tube members having various acoustic characteristics such as inner tube members 40, 42, 44 may be inserted, thereby the insert earphones having different acoustic characteristics can be easily obtained. In case where the inner tube members 30, 40, 42 and 44 are provided to the user as accessories, the user can easily replace the inner tube members to change the acoustic characteristics such as the classic and the rock. Thereby, the user can get the optimal insert earphone cheaply.

In the above described embodiment, part of the sound passage 16a is defined by each through hole 30a, 40a, 42a and 44a formed in each inner tube member 30, 40, 42 and 44, but other type of through hole may be applicable. Instead of these inner tube members, the sound passage 16a may be defined by an insertion member formed with a groove on the outer circumferential surface. Especially, in case where a spiral groove is formed on the outer circumferential surface of the insertion member, the distance of the sound passage can be extended effectively.

What is claimed is:

1. An insert earphone adapted to be inserted into an external auditory meatus, comprising:
a receiver unit having a sound passage tube, the receiver unit comprising a receiver main body and a housing which accommodates the receiver main body; and
an ear chip attached to the receiver unit;
wherein the sound passage tube comprises an outer tube portion integrally formed with the housing and an insertion member inserted into an inner space of the outer tube portion.

2. The insert earphone as claimed in claim 1, wherein the insertion member has a flange on a top end portion thereof, and the flange comes into contact with a top end face of the outer tube portion.

3. The insert earphone as claimed in claim 2, wherein a notch is formed on the flange, and a projection adapted to engage with the notch is formed on the top end face of the outer tube portion.

4. The insert earphone as claimed in claim 1, further comprising an acoustic filter attached to the insertion member.

5. The insert earphone as claimed in claim 2, further comprising an acoustic filter attached to the insertion member.

6. The insert earphone as claimed in claim 3, further comprising an acoustic filter attached to the insertion member.

7. The insert earphone as claimed in claim 1, wherein the insertion member has a through hole or a groove formed in the shape of a spiral.

8. The insert earphone as claimed in claim 2, wherein the insertion member has a through hole or a groove formed in the shape of a spiral.

9. The insert earphone as claimed in claim 3, wherein the insertion member has a through hole or a groove formed in the shape of a spiral.

10. The insert earphone as claimed in claim 1, wherein the insertion member is detachably attached to the outer tube portion.

11. The insert earphone as claimed in claim 2, wherein the insertion member is detachably attached to the outer tube portion.

12. The insert earphone as claimed in claim 3, wherein the insertion member is detachably attached to the outer tube portion.
